(19) United States
(12) Patent Application Publication
(10) Pub. No.: US 2020/0372545 A1
(43) Pub. Date: Nov. 26, 2020

(54) Viral booster

(71) Applicant: Sridat Chinsammy, Schenectady, NY (US)

(72) Inventor: Sridat Chinsammy, Schenectady, NY (US)

(21) Appl. No.: 16/350,530

(22) Filed: Nov. 28, 2018

Related U.S. Application Data
(60) Provisional application No. 62/708,051, filed on Nov. 30, 2017.

(51) Int. Cl. G06Q 30/02; G06Q 50/26; G06Q 50/00; G06F 16/28; H04L 12/58; H04L 29/08

(52) U.S. Cl. CPC G06Q 30/0273; G06Q 30/0277; G06Q 50/26; G06Q 30/0201; G06F 3/0482; G06Q 50/01; G06F 16/285; H04L 51/32; H04L 67/10; G06Q 30/0205

(57) ABSTRACT

The preferred embodiment of my Revolutionary Invention of the (VB™) is the Business Model, which will be practically represented, as an accessible Commercial Business Hub (a Digital bank of Operating systems). That will be uniquely integrated with the HP™, SC™, ChinStine™, AVRP™, CWW™ & LP™.

In which the configurations of the HP™ &the latter mentioned entities may varies from each other. Its mediums of Users Interfaces will; be the optional usage of Implements Hosted within the configuration of the HP™ and further entails interactions with; an AVRP™, ChinStine™, CWW™ &EIDDHA™. It will be the sole medium with the option to; remedy, super advance the other steps towards improvements of the entire base of the conventional social networking platforms and simultaneously provides its implementer with Colossus Economic Benefits via the Broad Distribution and Sale of Free Speech/Content (Advertizing etc).

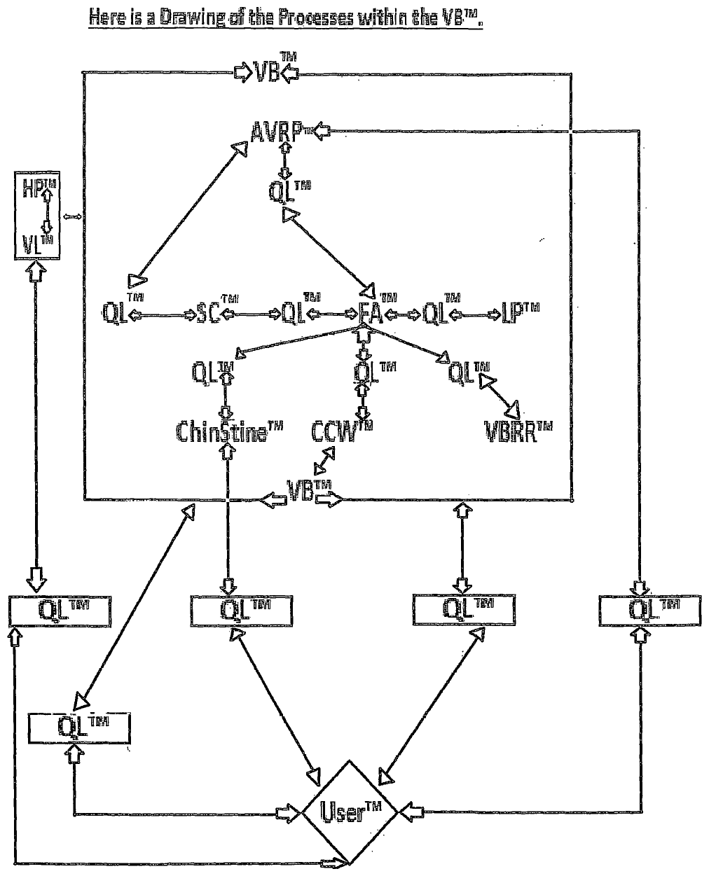

### CROSS-REFERENCE TO RELATED APPLICATIONS

This application is a continuation of U.S. Provisional Patent Application No. 62/708,051; that was filled on Nov. 30, 2017 and is now incorporated by reference in its entirety.

### BACKGROUND OF THE INVENTION

The internet is comprised of an enormous number of inter-connected computers and other interactive devices that are being used to facilitate the workings as; social media, e-commerce and advertising platforms. In 1991 the internet, was opened to commercial use and had led to the development of the E-commerce Industry. That has since grown into a Global Multi-trillion Dollar Juggernaut. That is consisted of a colossal List of entities that simultaneously advertised and sell products on it. In this process millions of Digital Pages have being generated. That can be effectively utilized by the Savoy Marketer (VB™) as a medium for Online Advertizing and the effective generation of Vast Amount of Revenues, for the said Savoy Marketer (VB™). At present this advertising is valued annually at approximately US $1 Trillion, on the Global Level. On the alternate hand Social media has its birth in 1997 and has made a tremendous surge in 2003 and from then on. It has made a formidable impact as a medium for advertising and all indications are pointing to the direction that it will remain with increase prevalence for time indefinite.

The species of advertising that is currently being executed via social media has a very recent history going back to just about a decade and has grown into an industry that has an Annual Worth of approximately US $60 Billion to date, on a Global Scale. It's a medium that offers the opportunity to the User to build awareness; target bases on geographic, demographic and behavioral data. In turn it has evolved into the concept of Relevant Marketing along with the problems that are associated with it. These problems are manifested when the User visit there family and friends, more especially when they are on the same social media platform. They are jammed with irrelevant ads in between the interactions and as a result, this action is causing negative results, to any ongoing Broad-base Campaign that they are seeking to purport.

Additionally, advertising via e-commerce platforms and social media fails to sustainably purport any Model on any given Platform. That provides Consistent and Meaningful Recompenses, to the Users for their indulgences with their advertisings! My revolutionary invention of the VB™ is providing expeditious Real Time Advertising Feed Optimization and Programming Advertising. As it distribute and broadcast Content (advertising and Free-speech), as it sustains Meaningful Users Recompenses for their indulgences with their Contents and simultaneous as it is harvesting. It's created effect of the inter-twining, among the participating e-commerce, social media and advertising platform. That creates the New Industry and Economic Model (VB™) wills carries a Global Revenue Base that is valued at approximately $10 Trillion over the next decade, based on the Inventor Conservative Estimates!!

The creation of Route Maps as suggested by the Inventor will work to suffice the Created Need. Those there inadequate counterparts have failed to provide. The fulfillment of this Created Need will allow merchants/distributors of products to readily access. A vast amount of the legally operating convenience stores and Delicatessen within desired geographic/demographic region. These revolutionary Route Maps will add Immense Economic Inflows and simultaneously increase Users Traffic for the VB™.

The CRSD™ will work to bring increased appeal for the Users to engage and utilize interactive products. That are related to the VB™ and simultaneously it will add Immense Economic Inflows for the VB™.

### BRIEF SUMMARY OF THE INVENTION

The preferred embodiment of my Revolutionary Invention of the (VB™) is the Business Model, which will be practically represented, as an accessible Commercial Business Hub (a Digital Bank of Operating systems). That will be uniquely integrated with the HP™, SC™, ChinStine™, AVRP™, CWW™& LP™. In which the configurations of the HP™& the latter mentioned entities may varies from each other. It mediums of Users Interface will; be the optional usage of Implements Hosted within the configuration of the HP™ and further entails interactions with; an AVRP™, ChinStine™, CWW™&EIDDHA™!

It will be the sole medium (“A Back of the Seen Operator,” that will enhance the capabilities of the HP™) with the option to; remedy, super advance the other steps towards improvements of the entire base of the conventional social networking platforms and simultaneously provides its implementer with Colossus Economic Benefits via the Broad Distribution and Sale of Free Speech/Content (Advertizing etc), in the Nature of both Digital and Hard Printed Matter!

It will be the Revolutionary Business Model with the added economic propensity to be considered as that of an E-commerce Economic Model! A mechanism that will provide all Users, with the Equal Opportunity, for each and every one of their Post to become Viral! Just, simply by their utilizing of the VB™ inherent, Innovation of “Flash Advertising™” (FA+™) and simultaneously it will be the Initiative that will cause all Users. To be exposed, to the realm of “Equal Enjoyment.” A privilege that will allow them, to be standing, on the Receiving End of Structured Recompense! That will be a direct product of their selective social indulgences, relative to; EIDDHA™, VL™, ChinStine™, AVRP™& CWW™!

Its operational model will be in direct contrast, to the entire Base of the conventional social networking platforms and all other online business models that offers recompense to it Users/Subscribers!

The VB™ Visible Manifestations will be the Web Pages of the HP™ and the subsequent, Web Pages. That will be activated as a result of the Users, interactions with; EIDDHA™, ChinStine™, VL™, AVRP™& CWW™! The VB™ will cause the HP™ to be able to effectively Distribute, Broadcast &Sell Content Advertizing/Free Speech, etc) on the Internet by the means of; Continued allowance to the HP™ for the Sale of Conventional Relevant Marketing and the Multiple Dimensions of FAT′″! Within these Multiplicity are; a New and More Refined Method of Relevant Marketing (TBP™), Broad Base Crossed the Board Marketing &Viral Lift™ (VL™)! These Accomplishments by the VB™ will be achieved in a manner in which it's Conjoining with the HP™. Will caused the availably of all of these Accomplishments, to be of a simultaneously and Symbiotic Nature. On the HP™, VB™, SC™, LP™, ChinStine™, AVRP™&CWW™ for any Given Period within its Operations!

The VB™ will readily remedy the “Sinister Killer Dilemma” that conventional social networking platforms are constantly encountering. This is the always lurking prospect of impending business obliteration, which continues to surreptitiously, harp at them! That is a product of the foregoing impedances; their reflected “Implicit Architecturally Shackled, Snail Drifting & Stifled Publication Pitches.” Their Business Models and Architectural affliction, with the “Sustainable Users Recompense Deficiency Syndrome” and the subsequent prospect of them being at the receiving end of the “Users Conventional Bouncing Ball and Finding Next Syndrome.”

In which the latter syndrome, does always points the light in the direction of the Users eventual non-apprehensive interactions and progressive disloyalty. With the conventional social network platform, that will eventually become yet another victim, of its destructive appetite! A product that has its genesis on a User, general lack of satisfaction/substantive “Indulge-able Zest,” with these platforms!

The “Indulge-able Zest” is the predominant sector of the problem that has a Genesis that is rooted in the fact. That the conventional social network platforms are constantly and extremely hard pressed to create new appeals in order to attract New Users and simultaneously maintain a Consistent Zest for the Users to exercise their continuous interactions with them. A dilemma of epidemic proportion within the industry! Relative to these preceding Dilemma and Impedances. The approach adopted by the still surviving, conventional social networking platforms. Have summoned into acts in which they have to constantly roll-out/acquire alluring products to attract New Users & retain those that they already have. In order to successfully maintain a very sizeable Users Base that is economically viable, to them!

The VB™ will create environments that will results into the continuous attraction of New Users and the development of Sincere Users Loyalty for the HP™! Conventional social networking platforms are constantly acquiring and executing the usage of new products and are experimenting with their usage. Praying that it will be an alluring product (the results have shown that they are proving to be somewhat alluring/total trash at times), actions that only can be summed-up to be of annoyance and repugnance to the Users.

Which only begs the Inevitable Questions; How Far Can the Creative Envelope be pushed, will there ever be an exclusive solution to this Colossus Dilemma? The great news is that the answer to the questions is YES and it is the VB™!

The VB™ is a product that has within its enablement, the active means to tackle and apply the “New and Useful Remedial Solutions.” For each aspect of this Colossus problems that have being highlighted in the foregoing paragraphs! With weighed emphasis in eradicating the limitations that inhibit the Commercial (Business Post) Marketing Publication (sales) Models; cumulatively provide the equal opportunity for Non-Business Oriented Post to enjoy the very same newly found privileges, provide a New & Useful Method for Users to Receive Sustainable Recompense for their Interactions and in all the workings continue to attract New Users and simultaneously maintains Existing Users Loyalty!

The ensuing materials will distill these intrinsic design issues; provide the method and means to accomplish such a Mega Task! It will provide the opportunity, for all HP™ Users (Social Media Users, Individuals& Business Entities) to optionally apply recompense towards the VB™. Then subsequently, they will be able to Up-load, Post, Distribute/Sell their Content (Advertizing Free Speech) online via FA+™! That will be made available on the very same web-site templates. That the VB™, HP™, SC™&LP™, will be using to transact and execute their Original Businesses Endeavors!

The VB™ is the initiative that will be the sustaining platform. That will attract and retain for the HP™. A constant and “never ending supply of loyal Users” in concert with similar blessings for the SC™&LP™!

The VB™ will be the sole Augmentable Platform but yet Autonomous Hub. That will present an alternate method of business to that of the entire Base, of the presently economically viable class, of conventional social networking platforms!

The VB™ will based its economic viability on the strength of the HP™ Users Base and the magnitude of their combined relationship as they integrates with the SC™& LP™ and actively sustains a Symbiotic inter-dependency with these just mentioned entities! With added emphasis on the fact, that the VB™ will be the Revolutionary Mechanism (New &Useful) that will provide the Equal Opportunity, for all Users to receive Structure Recompense for their Social Indulgences. That they will be executing, on the HP™/VB™, SC™, LP™, ChinStine™, AVRP™&CWW™! These Payments will be equated using a Unique Format that will be further distilled, in the latter embodiment of this Document!

The VB™ will be an Innovative Economic Change that is directly in stark contrast to the business models of the entire Base of the economically viable class of, Contemporary Social Networking Platforms and web sites that offers recompense to its users!

The VB™ will effectively, be a one stop solution to yet another present Major Problem that is adversely affecting a very sizeable number of conventional social media Users. This is a problem that is rooted in the overwhelming availability of a super stock band of mediocre social media platforms that inundate, annoys &confuses the public with their presence coupled, with their constant subtle and annoying allure to initiate public indulgences!

The VB™, HP™ SC™, LP™, ChinStine™, AVRP™&CWW™ will coherently, co-function with each other, as an Integrated Networks of Business but yet be able to securely maintain their original business identity and continue to maintain their Individual Ability to Compete, against each other! As they will work in symphony, to accomplish their respective Streamlined Business Goals.

### BRIEF DESCRIPTION OF THE DRAWINGS

The Drawing is a Label Representation of the embodiments of the VB™, with a typical configuration and directions of interconnections, as they are working coherently to achieve a functional Business Model.

### DETAILED DESCRIPTION OF THE INVENTION

I find it very necessary for me, to provide a section primarily dedicated to Definitions of; Terms, Abbreviations/Acronyms with their Synopsis, within this writing!

It shall be utilized within the composition of the; embodiment of the Viral Booster™ (VB™), its patent application Processes, and for all other associated species of Legal Interactions, whatsoever!

### Definitions of: Terms, Abbreviations/Acronyms with their Synopsis

Hosting Platform™ (HP™); All conventional designs of digital and social media with inclusiveness for those that are yet to be created and made practical, absoluteness to all species of websites what so ever and integrated web sites with the VB™.

Post; All up-loadable digital media, existing interactive and insert able contents on the; HP™/VB™, ChinStine™, an Augmented Virtual Reality Platform™ (AVRP™)&Cash Wrist Watch™ (CWW™) that are targeted for publication/re-publication on the; HP™/VB™, SC™, LP™, ChinStine™, AVRP™&CWW™ broadcasting mediums.

Likes+™; the relating/translation of all conventional Likes on social media, the manifestations of a positive review on a Post. That is represented by a Pulsating or Stationary Thumbs Up symbol of a desired coloration. That is be placed adjacent to the Likes+™ Impression within the HP™/VB™, AVRP™ &CWW™ web sites architectures.

Dislikes−™; the relating/translation of all conventional Dislikes/Thumbs Down expressions on social media, the manifestations of a negative review of a Post. That is represented by a Pulsating or Stationary Thumbs Down symbol of desired coloration. That is placed adjacent to the Dislike−™ Impression within the HP™/VB™, AVRP™ &CWW™ web site architecture.

Floats˜™; the tabulation/representation of all conventional Comments, on social media that is represented by the impression Floats™, accompanied by an adjacently placed Single or Multi-Colored/Iridescent Tilde (water symbol) within the VB™/HP™, AVRP™&CWW™ web site architectures.

User Action (UA+™); actions by Users on the; HP™/VB™, SC™, LP™, ChinStine™, (AVRP™) and (CWW™), towards Post/Web Alerts™ (WA™) & Viral Lift™ (VL™).

Followings@™ (F@™); the tabulation/representation of all UA+™ on the VB™/HP™, SC, LP™, AVRP™, ChinStine™&CWW™ that is not classified within the categories of actions originating from a Friend, on the basis their Account! It is represented by a Colored/Plain Dark Impression bearing a layout depicting the likeness of two/more human conjoining their hand and is published within the web site architectures of the HP™/VB™&AVRP™.

Sister Companies (SC™); are all affiliated entities of the VB™ that it is sharing an ownership interest in. They are entities that the VB™ will be simultaneously engaging and actively executing Integrated Business Network Connection with. Concurring actions as, it is actively engaging, with the other Business Entities. As they collectively works together and sustaining an economically viable & “Symbiotic Business Web!”

Linked Partners (LP™); are all affiliated entities of the VB™ that it will not be sharing an ownership interest in but will be simultaneously engaging and actively executing Integrated Business Network Connections with. Concurring actions as it is engaging with the other Business Entities. As they collectively works together and sustaining an economically viable & “Symbiotic Business Web”.

Threshold Viral Floats™ (TVF™); Chalk-up Credits, maturation volume of hits that a Post have to experience that is predetermined by the HP™/VB™, a product of the unique computation of these factors; Likes+™, Dislikes−™, Floats˜™, Friends and Followings@™. Account Specification (AS™); Users General Sign up Data, Financial Information & Preferences as required by the VB™/HP™ at any requested time.

On Box™ (OB™); a Digital ON-Demand Cabinet within the VB™ that is having among its architecture a conventional Email in-Box, like feature.

Platform Alerts™ (PA™); automatically send email/s into the Users, conventional emails inboxes, text messages/conventional “Hashtag” labeled services & similar social instruments.

Catalog Index™ (CI™); a systematic chronicling, cataloging and archiving of selective Posts on the VB/HP™. In a unique manner that will be dictated by the utilization of these classes of characters in the desired variations; Alpha, Numerical/Color Coded Impression.

Flash Advertising+™ (FA+™); a paid for, Time-Allotted Privilege that is allowing for the effectively fast delivery and unbiased distribution of Post. Those that are bound for Rapid (extremely expeditious) advertising, publication/sale via the VB™/HP™, SC™, LP™, ChinStine™, AVRP™&CWW™. It's a privilege that is utilizing the VB™, engineered public broadcasting (flogging) mechanisms of the EIDDHA™ WA™ &VL™.

Web Alert™ (WA™); is an independent web tool in the nature of an expressing character (the formatting and presentation of a post). That stands out as a pronounced product. That is having a partial genesis based on the selective usage of these characteristics; Specifically Colored, Iridescent, Insignia & an Impression that is of a Particularly Oriented Shape. That is selectively pulsating within its Hosting Web Tool the Embellished Iridescent Dynamic Double Helical Animation™ (EIDDHA™). As a Pulsating Element (WA™) is representing an Individual Post! These WA™ is susceptible to alteration/shifting of; Shape, Size and Color, according to the dictates of the VB™/HP™ Operating Systems. All WA™ is the expressed transition of a Post from being a Conventional (regular) Nature into a Post that is exposed to action of Flash Advertising+™ (FA+™). All, WA™ are a Super Contracted Rendering of a Post!

Embellished Iridescent Dynamic Double Helical Animation™ (EIDDHA™); as this name does incur suggestions that interlays with aspects of an Inherent Biological Design; is the Primary Hosting & Public Alluring Tool of the VB™ that is represented. As an enticing iridescent animated rendering of the DNA Molecule. It particularly mimics the Double Helical Structure of the DNA Molecule and bears within it layout a desired array of WA™ that are Confined within a Circumferential Border! The embodiment of the Double Helical Structure itself is constituted of a Systematic inter-laying of extremely Minute& Active WA™. It is the Tool of Enticements and Allure that is Emblematic, in Mimicking of the Appearance & Natural Functioning of the DNA Molecule, within Nature! That is working to accomplish the FA™ agenda of the VB™. It is engineered & implemented to accomplish the foremost task of propelling the marketing ambitions of the VB™. It is engineered to be controlled by the User as it becomes a Morph-able & Stationery Logo that transition into a Temporary Facilitating Tool of the VB™. That is functioning as the Internal Search Engine, for the Data Base of WA™. This Capability is allowing the User to readily search, the VB™ Data Base of WA™ and locate within specific Business Entities. That is facilitating the Users interactions with them/acts of saving into their OB™ for latter interactions. The EIDDHA™ is allowing the Users interaction with the WA™ and enablement to Upload a Promotional Code/Receipt Number, etc that they have from the WA™ Posting Entity. Subsequently they are made to receive Action Based Recompense from the VB™ via it Payment Structure (Viral Booster Recompense Regime™) (VBRR™)/the User on the alternate hand is able to down-load the WA™ Posting Entity Promotional Material and used it for Discounts, during shopping from the entity/it affiliates! EIDDHA™ is strategically hosted and published within the broadcasting mediums of the HP™, VB™, SC™, LP™ ChinStine™, AVRP™&CWW™. **It is not going to be restricted to the confines of the design limitations based, on the just expressed Model!

Digital and Social Media; all species of functioning wed sites, with emphasis on conventional web platforms, that allows for the Free uploading of Digital Media/Generation of Content, within their web site architectures/broadcasting mediums.

CHIN™; is the VB™/HP™ Sales Avatar that is made manifest as an animated product. That represents the optional portrayal of either a Male or Female character, that will serves the Users at their interactive urge.

Relevant Marketing; is the Conventional Methodology used for the; Distribution, Broadcasting & Sale of Content (Free Speech& Advertising) that Conventional Social Networking and E-Commerce Entities are using.

### The Inventor's Legal Rendering

The VB™ is imputing that a “Post” (its Article for Disposal) is of the Legal Composition; it is the Electronic Construct that is Representing the Perimeters within the Formulations that are deduced as a result of the Workings within a Physical Object, thus Rendering the Resulting Product to the Public(Users) for Sale and Consumption and this Product is an Inter-coop of the Dimensions within the Construct of the “Act of a Sale”!!

### DETAILED DESCRIPTION

The preferred embodiment of my Revolutionary Invention of the (VB™) is the Business Model, which will be practically represented, as an accessible Commercial Business Hub (a Digital Bank of Operating systems). That will be uniquely integrated with the HP™, SC™, ChinStine™, AVRP™, CWW™& LP™. In which the configurations of the HP™&the latter mentioned entities may varies from each other. It mediums of Users Interface will; be the optional usage of Implements Hosted within the configuration of the HP™ and further entails interactions with; an AVRP™ ChinStine™, CWW™&EIDDHA™!

It will be the sole medium (“A Back of the Seen Operator,” that will enhance the capabilities of the HP™) with the option to; remedy, super advance the other steps towards improvements of the entire base of the conventional social networking platforms and simultaneously provides its implementer with Colossus Economic Benefits via the Broad Distribution and Sale of Free Speech/Content (Advertizing etc), in the Nature of both Digital and Hard Printed Matter!

It will be the Revolutionary Business Model with the added economic propensity to be considered as that of an E-commerce Economic Model! A mechanism that will provide all Users, with the Equal Opportunity, for each and every one of their Post to become Viral! Just, simply by their utilizing of the VB™ inherent, Innovation of “Flash Advertising™” (FA+™) and simultaneously it will be the Initiative that will cause all Users. To be exposed, to the realm of “Equal Enjoyment.” A privilege that will allow them, to be standing, on the Receiving End of Structured Recompense! That will be a direct product of their selective social indulgences, relative to; EIDDHA™ VL™, ChinStine™ AVRP™ &CWW™!

Its operational model will be in direct contrast, to the entire Base of the conventional social networking platforms and all other online business models that offers recompense to it Users/Subscribers!

The VB™ Visible Manifestations will be the Web Pages of the HP™ and the subsequent, Web Pages. That will be activated as a result of the Users, interactions with; EIDDHA™, ChinStine™, VL™, AVRP™& CWW™!

The VB™ will cause the HP™ to be able to effectively Distribute, Broadcast &Sell Content Advertizing/Free Speech, etc) on the Internet by the means of; Continued allowance to the HP™ for the Sale of Conventional Relevant Marketing and the Multiple Dimensions of FA™! Within these Multiplicity are; a New and More Refined Method of Relevant Marketing (TBP™), Broad Base Crossed the Board Marketing &Viral Lift™ (VL™)! These Accomplishments by the VB™ will be achieved in a manner in which it's Conjoining with the HP™. Will caused the availably of all of these Accomplishments, to be of a simultaneously and Symbiotic Nature. On the HP™, VB™, SC™, LP™, ChinStine™, AVRP™&CWW™ for any Given Period within its Operations!

The VB™ will readily remedy the “Sinister Killer Dilemma” that conventional social networking platforms are constantly encountering. This is the always lurking prospect of impending business obliteration, which continues to surreptitiously, harp at them!

That is a product of the foregoing impedances; their reflected “Implicit Architecturally Shackled, Snail Drifting & Stifled Publication Pitches.” Their Business Models and Architectural affliction, with the “Sustainable Users Recompense Deficiency Syndrome” and the subsequent prospect of them being at the receiving end of the “Users Conventional Bouncing Ball and Finding Next Syndrome.”

In which the latter syndrome, does always points the light in the direction of the Users eventual non-apprehensive interactions and progressive disloyalty. With the conventional social network platform, that will eventually become yet another victim, of its destructive appetite!

A product that has its genesis on a User, general lack of satisfaction/substantive “Indulge-able Zest,” with these platforms!

The “Indulge-able Zest” is the predominant sector of the problem that has a Genesis that is rooted in the fact. That the conventional social network platforms are constantly and extremely hard pressed to create new appeals in order to attract New Users and simultaneously maintain a Consistent Zest for the Users to exercise their continuous interactions with them. A dilemma of epidemic proportion within the industry!

Relative to these preceding Dilemma and Impedances. The approach adopted by the still surviving, conventional social networking platforms. Have summoned into acts in which they have to constantly roll-out/acquire alluring products to attract New Users & retain those that they already have. In order to successfully maintain a very sizeable Users Base that is economically viable, to them!

The VB™ will create environments that will results into the continuous attraction of New Users and the development of Sincere Users Loyalty for the HP™! Conventional social networking platforms are constantly acquiring and executing the usage of new products and are experimenting with their usage. Praying that it will be an alluring product (the results have shown that they are proving to be somewhat alluring/total trash at times), actions that only can be summed-up to be of annoyance and repugnance to the Users.

Which only begs the Inevitable Questions; How Far Can the Creative Envelope be pushed, will there ever be an exclusive solution to this Colossus Dilemma?

The great news is that the answer to the questions is YES and it is the VB™!

The VB™ is a product that has within its enablement, the active means to tackle and apply the “New and Useful Remedial Solutions.” For each aspect of this Colossus problems that have being highlighted in the foregoing paragraphs!

With weighed emphasis in eradicating the limitations that inhibit the Commercial (Business Post) Marketing Publication (sales) Models; cumulatively provide the equal opportunity for Non-Business Oriented Post to enjoy the very same newly found privileges, provide a New & Useful Method for Users to Receive Sustainable Recompense for their Interactions and in all the workings continue to attract New Users and simultaneously maintains Existing Users Loyalty!

The ensuing materials will distill these intrinsic design issues; provide the method and means to accomplish such a Mega Task! It will provide the opportunity, for all HP™ Users (Social Media Users, Individuals& Business Entities) to optionally apply recompense towards the VB™. Then subsequently, they will be able to Up-load, Post, Distribute/Sell their Content (Advertizing Free Speech) online via FA+™! That will be made available on the very same web-site templates. That the VB™ HP™ SC™&LP™, will be using to transact and execute their Original Businesses Endeavors!

The VB™ is the initiative that will be the sustaining platform. That will attract and retain for the HP™. A constant and “never ending supply of loyal Users” in concert with similar blessings for the SC™&LP™!

The VB™ will be the sole Augmentable Platform but yet Autonomous Hub. That will present an alternate method of business to that of the entire Base, of the presently economically viable class, of conventional social networking platforms!

The VB™ will based its economic viability on the strength of the HP™ Users Base and the magnitude of their combined relationship as they integrates with the SC™& LP™ and actively sustains a Symbiotic inter-dependency with these just mentioned entities! With added emphasis on the fact, that the VB™ will be the Revolutionary Mechanism (New &Useful) that will provide the Equal Opportunity, for all Users to receive Structure Recompense for their Social Indulgences. That they will be executing, on the HP™/VB™, SC™, LP™, ChinStine™, AVRP™&CWW™! These Payments will be equated using a Unique Format that will be further distilled, in the latter embodiment of this Document!

The VB™ will be an Innovative Economic Change that is directly in stark contrast to the business models of the entire Base of the economically viable class of, Contemporary Social Networking Platforms and web sites that offers recompense to its users!

The VB™ will effectively, be a one stop solution to yet another present Major Problem that is adversely affecting a very sizeable number of conventional social media Users. This is a problem that is rooted in the overwhelming availability of a super stock band of mediocre social media platforms that inundate, annoys &confuses the public with their presence coupled, with their constant subtle and annoying allure to initiate public indulgences!

The VB™, HP™ SC™, LP™, ChinStine™, AVRP™&CWW™ will coherently, co-function with each other, as an Integrated Networks of Business but yet be able to securely maintain their original business identity and continue to maintain their Individual Ability to Compete, against each other! As they will work in symphony, to accomplish their respective Streamlined Business Goals.

Additional Traits& Dynamics within the VB™;

The VB™ will facilitate Payments by Users to Post Contents. It will hold in isolation ASTM in secure servers that will be of both the Digital & Mechanical Designs. That will be readily accessible in a stealthy manner by the VB™ Sales Avatar, CHIN™! Upon CHIN™ sensing of the HP™ User intent to upgrade their status from a Regular User to a USER+™. CHIN™ will actively work to protect this information from Hackers via the actions. In the apparatus that is within the VB™ multi-layered security System the “Quantum Lock™ (QL™).”

The VB™ “Mechanical Servers” will accomplish the purpose of providing the Sounds generated from it Operating Mechanics; as an attention grabber and a constant remainder to its Listeners of the active intent of the HP™& VB™ Business Models! These Quantized Sounds (Consistent Audio Stimulator™ (CAS™)) will stand-out as a stimulus that is very different for the Normal Sounds created from within a modern office work place! It will be in stark contrast to the active Digital Servers. That is mostly the sole species of server equipments that are within usage in a Conventional Network Services. This resulting Distinctive Product (CAS™) will be providing the services as, the Humming Beacon! Those will in-turn acts as the Medium to its Listeners that will; Invigorates, Impels/Spurs their Dedications & Creative Sprits, toward the Burnishing of the VB™&HP™ Business goals! The CAS™ will be selectively tailored to be an interblend having within “Potions” of Contemporary Music! This unique infusion is of the primary intent to eradicate of any possibility of the CAS™ being of a Mundane Nature from creeping up onto it effectiveness!

The CAS™ will additionally fortify its functions and perform the purpose of a Constant Sounding Bell. Of the HP™ and VB™ that will stimulate and reminds their employees/associates. That there exist within them atmospheres of creativity with the added opportunity for them to pursue Capitalistic Goals, that are Cultured and Fitted to be Financially Beneficial to the HP™&VB™ and Them-self!

The implementers of the CAS™ shall be very confident and rest assured that the unique invention of the CAS™ will fulfill it intended creative objectives!

The VB™/HP™ will ingeniously utilize the CAS™ and further construed their energies to foster a very effective Interrelation (Symbiotic) Relationship between them Self and their Employees!

The VB™ will be a Rating House, which will provide the Users with the platform to present ratings for all of their Posts. With the programmable inclusiveness for diversification on Ratings, relative to what is Trending Online, at any point of time. Its algorithms will accomplish this task, by systematically, Searching, Filtering-out of information from the Internet (Automatic Internet Activity). That it will eventually cataloged and archived into a Displayable File on the OB™ the Trending Booth™ (TB™).

The just preceding mentioned task will be accomplished by the VB™ as a product of its programming languages. That will be articulating in the nature of Automatic Internet Activities, on pre-determined time durations. For each increment of actions that will be set forth within their configurations. Thereby enriching its Server System with information, this will be used for Printed& Digital Transcriptions (printed matter in the nature of a magazine the Chins Report™ that will be very much comparable to the conventional magazine Consumer Reports)!

The HP™ Users will be able to access direct connections to the VB™ via their interactive actions relative to a Key+™ Symbol on their HP™ pages and by interacting with EIDDHA™ ChinStine™, AVRP™, CWW™&VL™!

The VB™ will be a gargantuan, shift from the conventional Social Media Business Models, as prime and moving opposite, to their Distribution & Sales Nature!

The VB™ will be an Equal Prime Business Mechanism & Catalysis that will be providing, the avenues from within it Payments Structure. To make the possibility to all HP™ Users, for their “PA™ Associated Financial Contributions.” To become the catalysis that will enable the enhancement of their Posts. On the HP™/VB™ SC™, LP™, ChinStine™, AVRP™ &CWW™ to “Most certainly” become Viral!

The VB™ will constitute within its architecture the Faucets for SC™. LP™, ChinStine™, AVRP™&CWW™ that can be integrated/disintegrated within its functions, on an ongoing basis. These mediums will be a Cornerstone and Indulge-able Apparatus that will be effectively used by the HP™/VB™, to immensely broaden its Distributions/Sales Bases. With consideration that this, Unique and Gargantuan Sales Endeavour will be made practical, by the utilization of EIDDHA™&VL™!

The VB™ will be the augmentable medium that the HP™, SC™, LP™ ChinStine™, AVRP™ &CWW™ will be able to merge with. It will produce a coherent and fruitful business relationship. It will operate on the premise whereby it will facilitate the HP™. To acknowledge and systematically processed all of its Posts by virtue of its programming languages.

The VB™ will be the Revolutionary Economic Engine that has the potential to generate, Tremendously Vast Amounts of Revenue for it implementer! A reality that will be influenced by the, effective Distributions & Sales of each Post!

The VB™ will be highly capitalizing and pivoting its sales operations on a core Business Philosophy that “almost everyone who is alive does have a View that they wants to Express &Publish”, here in referred to as the “Expressive Class.” This inherent dedication by the VB™ will be a gargantuan commitment to the broadcasting. Of the desires of the expressive class (Users+™) that falls out of the Classification of the HP™ Conventional Business Class Advertisers!

There exist statistically, among the “Expressive Class” people who are very willing to pay a Reasonable Fee. With the anticipation of making; their Views known, having their Pictures and Posts (Content) broadcasted to the Open World and in the process make New Friends and the Building up of a Following+™. With ample consideration on the fact that we are living in the New Age of “Selfies,” the VB™ will work to make this Pop Culture trend a Real Money Minting “Viral Phenomena!” Additionally, the VB™ will place heavy emphasis on these under mentioned Reasons Why People Post and work actively to promote their Causes and enhance the possibility of it to going Viral!

### Reasons

a) To be Liked/Loved by others especially to enjoy the Physiological Rewards that is associated with the expression of these Feelings.

b) To share their views and options relative to Subject Matters.

c) Wanted to spread special messages.

d) Wanted to examine the Users views relative to theirs.

e) Wanted to sell Products.

f) Wanted to feel accepted by members of the public.

g) Wanted to feel important and mattered.

h) Wanted to create a Following.

i) Wanted to take away from their connections an Influential Impact.

The VB™ will be the “Optional Alternate Solution” at the disposal of the Users! Who want to Tackle the Following Problems that Relevant Marketing (Content Marketing) is Presenting to its Users:

A) It's Elements are very Difficult to Accurately Gathered and Implement!

B) It's very Costly to Implement and Execute!

C) It's an Advertizing Method that Strains Companies and Individuals Budgets.

D) It's requires lot of Data Gathering and Usage of a lot of Technology to Formulate and Execute!

F) It's prone to Catastrophic Failure due to the usage of In-accurate Data in its Genesis and this Defect (Flaw) can only lead to it being Published towards the Wrong Audience (the Lost of Money &Time)!

The VB™ will be the Innovative Mechanism that will most genuinely cause Content (Post) to go Viral. It is predicated, on the premise that it is functioning as an Integral Component of an Economic Model. In that it Interplays the disbursements of Recompense for Indulgences, relative to a Post. The Recompense will further fortify the Conventional Factors that invigorates a Person to Share Content!

The VB™ will be a deep step, onto a new direction of e-commerce (business) away from the conventional social networks sole mode of generating revenues, ushering in a New Age of prosperity for Social Networking and the world of E-commerce (a Sole Economic Model)! All social media Users will be able to sustain a very Genuine Guarantee of being able to present their Post for “Flogging” via the broadest global broadcasting mechanism available. This paid for privilege will foster a Moto of “No Prejudice Whatsoever,” meaning that the embodiment (with the exception of Pornography) of a Post will not be a determining factor, for its publication. Disregard-less of how meager their content, might appear to, be in the eyes of their fellow Users, acquaintances/critics etc!

The VB™ will be the revolutionary medium (Forum) that will provide this class of Users with the equal and ample opportunity to counter their critics' opinions and possibly Provide the Prelude for the Critics to change their Views, relative to their Criticism!

The VB will be the breakthrough mechanism that will creates an avenue that will present the means for, what would have being an Mundane Post to become Viral, thus leveling the playing field as they relates relative to the publication of Business Post (advertising)! “All Expression will have an Equal Opportunity to become Viral!”

The VB™ will start to automatically retain and systematically catalog a continuous record. That will be comprised of all of the; Likes+™, Dislikes−™, Floats˜™ and Followings+™ expressed towards each Post on the Catalog Index™ (CI™). This CI™ will also be kept as Digital& Directly Printed Files. That will be the product of a plurality based counting method, of the Users Input. The CI™ will be used to provide information to Data Consumers etc!

The VB™ will act upon a Post attainment of the TVF™, by automatically sending email/s into the Users, conventional email Inboxes (OB™) and Text Messages (Unless pre-indicated by the User of an alternate desired spread of action, within its ASTM). These messages will be used by the VB™ to indicate to the User that their Post have reach the TVF™ and that they are exposed to the privilege. To follow the VB™ Set-up Payment and Distributions/Sales Structure. Further indicating that in so doing mature themselves into a FA+™ Utilizing User (User+™) and this will be an empowerment that will allow them to have the

HP™/VB™ SC, LP™, ChinStine™, AVRP™&CWW™ at their disposal making presentiment/s on their behalf, to all of its Targeted Users!

The VB™ will additionally, present another Viral Flogging (Broadcasting) Tool in the nature of a Cross-the-Board Herald, the Viral Lift™ (VL™)! This will be only subsequent to Payments by Users who's Post has reached the TVF™! The VL™ will be a Status Indicator, in the nature of a pulsating/stationary Insignia, which will be interlaid relative to the Post as it is being display on the HP™ The VL™ will easily facilitate all of the HP™ Users interactions with the Post. By interacting with the VL™, all HP™ Users will be allowed the option to immediately insert a; Like+™ Dislike−™, Float_™/Following+™. On to the Post or further be able to save the post. Into the CI™ for further interaction at latter chosen time. The CI™ will cause the Post to be stored and chronicled into sub-sections of Friends/Followings. Where it can be latter accessed on the VB™. The latter access is indented to readily facilitate the Users in interacting with Posts of Individual VB™/HP™ Users+™. In so doing it will allow the User to express preference for specific Users+™ Post (WA™&VL™) and store them for latter action and request for recompense!

The VL™ will be the Distinguishing Indicator that will separate Posts that have being out rightly being paid for to be exposed to the enjoyment of FA™ and those that have reached TVF™ prior to their exposure to FA™!

When the User interacts with a Post that is aligned with the VL™ it will allow them to be at the receiving end of the VBRR™!

The VL™ is mechanism that will further actively complement the course of actions that makes a Post go Viral! On the Alternate Hand, the other path to the direct enjoyment of the privilege of FA+™ is the usage of the VB™ Set-Up Payment Structure. Whereby the User can directly Pay and Upload a Post and Start Immediately to enjoy the privilege of the FA™. Without having to wait for the Post to reach the TVF™ and immediately Amplify the Possibility of Making their Post Going Viral!

The Set-Up Payment structure will dictate the running time of a Post Upon the fulfillment/attainment of any of these outlined criteria. The VB™ will cause the HP™ SC™, LP™, ChinStine™, AVRP™&CWW™ to automatically sent Displayed WA™ via EDDHA™ to all of their Users across the Board! These WA™ will last for 10-30 seconds (the Window of Opportunity) or to the alternate a period of time pre-determined by the VB™.

This Widow of Opportunity will be allowing a Running Time for all Users Interactions, towards a WA™. There will be a continuous band of Posts that will be displayed to the User base on a sequence. It will be determined by the time of its recognition of maturation of a WA™. These displays on to the HP™, SC™&LP™ will be a happening that is made possible due to their augmentations with the VB™

The VB™ will make certain that Users who do not respond to the PA™/those that Optionally Opt out of its, payment Opinion/s. Will not be Penalized/made to Experience Bias (No Prejudice Guarantee). In any manner, whatsoever but will be allowed to enjoy the regular privileges of the HP™, conventional “Flogging” (broadcasting) mechanism. This occurrence will be without it being made obvious to the remainder of HP™ Users. That there was an alternate course of Chosen Actions by a portion of Users!

The VB™ will also be equipped with the unique ability to execute a New Breed of Relevant Marketing that is more Intriguing. In that its Limited Targeted Distribution, Broadcasting & Sale Model, the (Tailored Blitz Punch™ (TBP™) will be, Super Faster in its outreach capacity. As in direct contrast to the conventional on-line, “Fractured Methods” of conventional Relevant Marketing. It will be prone to Tailoring by the Users+™, so as to concentrate its broadcast & sale outreaches relative, to the specifications that are within their desires. The Tailoring of these materials will be facilitated by the special algorithms of the VB™. These specifications will be configured within the following categories of classifications; Geographic Boundaries, Age, Sex, Likeness and other determining factors! The TBP™ will be utilizing all of the applicable VB™ initiatives (Mechanics), to the fullest extent possible. That are underpinned within its; FA™ Mechanisms and VBRR™ Structures! The TBP™ as its name helps to suggest its Swift &Direct (specific outreach) Intents! In that it will be engineered, to be in direct symphony to the characteristics within the functioning nature. Of the operations that are associated with a “Targeted Blitz” (Streamlined & Narrow Relevant Marketing)! It is engineered for the Super Expeditious and Streamlined Broadcasting & Sale of Free Speech/Advertising via the VB™ and it Avenues of Distributions, Broadcastings and Sales.

The VB™ will become the largest and most establish practical exercise of Business Interdependency and Cross-competition within an effectively functioning Business Web! By not accommodating the usage of FA™ within their operations. A business will Risk the possibility, of Failing to reach that Special Community of People, from within the Public! That will only place them in direct Contrast and Disadvantages, to their competitors! The Non-business Users of the VB™/HP™, will be left with the Toxic Options; of having to resort to using the so-called Experts Tips, Maneuvers/Tricks to make their Post go Viral! In so doing they will have to Individualize their Action for Each and Every Post! That they wants to go Viral (a Gargantuan & Daunting Task) and simultaneously placing them self in the precarious situation of Eminent Failure!

The VB™ will be an Independent Business Model that will relies on its augmentation with the HP™ for its functioning as a Semi-autonomous Entity. That will be providing Sustainable Recompense to its Users, as a direct result of Tailored Action towards a Tailored Reciprocating System.

The VB™ will introduce a “Probationary Marketing Period” that will be functioning as the “Spurring Marketing Pitch”, with the intent of Upsizing the HP™ and VB™ User Base and Encouragement Mechanism, to Users for their Usage of FA™ That will function within the dynamics whereby; Indiscriminate & Randomly Selected Posts from the HP™ will be exposed to the enjoyment of FA™ at No-Cost to its Uploading Users! That will be the initiative to establish the effectiveness of FA™, as the Premiere Broadcasting & Marketing Mechanism of the VB™. During this period the HP™ Uploading-Users will be notified by the VB™ that their Posts have being selected for FA™! This Free Introductory Period will be a Further Legal Enticement to the Users by encouraging them. To continue utilizing the VB™ Marketing Initiative of FA™. That structure when Equated can only be translated to noting other than; VB™′ Free Broadcasting & Marketing Initative+Limited Time WA™& Indulgences=Remarkable Results+Users Recompense!

The VB™ will enable the OB™ to retain the Favorite Post of the Users and it will be equipped with the ability to facilitate the deletion of any Post, which the User happens to select for such an action.

The VB™ will be equipped with the ability (Analytical Tool) to conduct a Google like Internet Search of already made Public Information. That will be based upon a Plurality Oriented; Typed Texted Search Request/an Audio Request or by the Tough of its Graphic Embodiment or Digital Characters or a click of the Mouse as a result. Of a Cursor Identification, hovering or hard press action onto a WA™. The Google like Internet Search of the WA™ will be to locate find if contents within a WA™, is trending and where it is trending on-line. The detail result of the search will then be gathered by the VB™, be tabulated and transfer to the post layout for uploading, on to the User+ Home Page/Feed Page on the HP™ and be formatted to be presented in Printed Matter!

This Analytical Tool within the VB™ will calculate and tabulate the volume of All Positive and Negative Responds the WA™ had being exposed, to across the Internet at the time of the search. This information can be accessed by the User+™ and be prompted for re-publication on the HP™ via the User+™ News Feed and other relevant pages. Every, Users OB™ will all times maintain a specific section whereby the User can save their Favorite Posts, Not-Too Fussy Post and Most Dislike Post (Slots) along with their full contents inclusive of all Floats in a well streamlined manner.

The VB™ will allow for Singled out aspects of Posts to be edited by the User and then be saved, in the original order as they were imputed in a new slot named the Altered Corner (AC™). All these Slots within the OB™ will be of an embodiment that will facilitate the easy Cross Referencing of their Contents relative to each other. They will be having Tools within them that can search for Similar Post and Contents and present them in a Result Box™ (RB™) That in turned can be stored in a Cataloged Manner by the Users/be Deleted. These sections of the User OB™ will allow the User at any given time to click, on the Plurality Image or Terms that it have originally auto generated for filing and storage purposes. These actions will be of the enablement of its programming language (Architecture of the VB™), that will be allowing for the generation and the conducting of an up-to Present Time Internet Searches for each Post. These Updates then can; be further be Saved within the Slots/be posted on the Users Home page/be inter-shared within Users. Each Saved/Shared posts will be Chronicled and Timed Stamped/further be made into Printed Matter!

The User will be able to attach a Float˜™ if desired/express a Like+™ or Dislike−™ for the Post. The post will then be automatically be uploaded into the HP™ web Pages, belonging to the Uploading User simultaneously the Viewing User will be presented with the Option to Store the Post or discard it from there OB™. The Post will be automatically be uploaded onto the HP™ web Page after the action of the First User who can add; a Like+™ Dislike−™/Float˜™ on to it. Subsequent similar UA™ action will result in their Like+™, Dislike−™/Float˜™ being posted.

Along the designated Spot next to the Post in a First come First Register Manner and the display of a Streamlined Numerical Tally of all Like+™ Dislike−™&Floats˜™ to the Post.

Posts accessible by the User will uniquely be allocated a conjoin space for the User to attach a Tag Name™ (TM™) on to it for storage in the User Favorite Section of the OB™. An additional feature within the OB™ configuration will be an easily accessible Shadow Drop Down Portal. That will be activated by the Users; Cursor, Hard Press or Hovering Actions, or Touch presence on the Post. As it function as that of a self-standing fully cataloged section by itself. This Shaped Based, Alpha Numerical& Color Coded Index (The Conifer Stone™) will bears information about the HP™/VB™ and Sub-classifications (categories) for each Post as it collectively groups them. The Up-loading User will be able to see at all times on their Main Page of the HP™/VB™ other Users, Reactions Relative to their Post in real time as practical! All Cross Board Reviews will be displayed of the Demographic Data that highlights the Country, State, County, City and Zip Codes (USA Classification) of the Origination of each Comment (it will aid the viewer to refined there deductions). In the cases of International Cross the Board Reviews the displayed data will be of similar categorization as the, USA Based Classification. The Users will be able to further input; Likes−™/Dislikes−™, Likes+™/Floats˜™ to already active comments and already Existing Expression. It will be an unrestricted flow of Likes+™, Dislikes−™/Floats˜™ that will be keeping the Discourse Going! All of the foregoing Intricate Indulgences/Spins can be accommodated for Recompense via the VBRR™!

The VB™ will be exposed to the optional utilization of the Personal Stunner Advertising Spin (a “Guerilla Self Promoting Marketing Strategy”) that will be in the nature; of Printed Matter (Advertisements) on the Back/Front of every USPS, Fed EX, DHL &UPS (every agreeable courier, including those in the PCT member states) Sales Receipts! In the nature of a singular approach of the just mentioned SUIT or in selective combinations of each entity within the Suit. This Optional Business Advertising Endeavor within the structure of the VB™ Personal Sale Framework. Will be utilized to remind, the public of the Constant On-going Presence and functioning, of the VB™& its Business Associates! It is well documented that each of these entities within the Suit has very far Reaches within the USA and the International Business world. They each have very broad reach to especially the inhabitants of the United States and eventually the agreeable, PCT member states. This Stunner Advertising Spin can be negotiated in an incremental basis with the just preceding mentioned business entities and can be utilized progressively, by the VB™!

Additionally, the “Butterfly” will be part of the “Gorilla Self Promoting Marketing Strategy” of the VB™ and will be used to present Audio/Digital Messages (Adds)! At all level of Human Gatherings both Indoors& Outdoors. It will be fundamentally resting on the principle where a Self-deploying and Retractable Auto-inflatable and De-flat able Blimps will be disseminating messages. Of an Outlined Nature of Advertizing, routing the business interest of the; VB™, HP™, SC™&LP™ in any desired combinations!

The VB™ will be an augmentable ready platform to Music/Audio Based Websites and will be equipped with the capability, to share its Contents. It will cause all Musical& Video Post uploaded to the HP™/VB™ those that it interacts with. To be automatically analyzed and conveniently made known in the manner of Time Delayed Statements. That will be construed within the nature of a Digital/Audio Message that will be presented within the User viewing Page. The core contents of the message will be the; Name of the Music, the Artist/s (Band), the Year of its Production & its volume of sale, etc. All in conjunction with added emphasis, on the presentment of very accurate Data, within its music publications. There will be within the HP™ Terms Condition/Legal Sections written rules that will be applied to immunize itself from Legal Acts, of being liable for these publications! The presentment of the information will be in the nature of Written Matter, for Users of these classes; the Hearing Impaired & those who prefer to view Silent Videos! The VB™ will act in this nature; as the Collecting Basket that will accepts Users uploaded Music Likeness & Video Preferences Data and readily make the said easily accessible to the Users. Whereby they can initiate the Automatic, To and Fro Transfer/s of the desires contents within Music/video Platforms, to facilitate the Broadcasting of their Contents.

The VB™ will have within its repertoire a “Quantum Leap” in its outreach scope that will operate on the principle. In which any Platform that utilizes it services will be able to provide to the Public. The Immediate Opportunity to be exposed to the enjoyment of having access to Free Internet connection; via the HP™ App/the VB™ mechanisms of FA™ (EIDDHA™&WA™). From any Wi-Fi, Ready Device that is not having within its Subscription at the time the ability to be connected to the internet. That will include within its Class Members of the Public; that will be possibly facing Financial Hardships and will be unable to pay for Internet Connection and those that are in locations where their Internet Services don't function. Extreme consideration will be placed on the fact that a very significant volume of Internet Users are receiving data on the basis of a Supply Plan.

The just discussed preceding actions will allow all HP™ Users and those SC™&LP™ Users that will utilized the VB™ mechanism of FA™ that will be under a Supply Plan. Which carries a Limited Data Supply, to be Selectively and Automatically, be exposed to usage of the enablement of the VB™. This “Quantum Leap” in outreach will serve to solidify a “Statically Sound & Economic Bearing Rostrum” for the VB™ SC™&LP™. This initiative by the VB™ will be an element that will be a Game Changer that will immensely influence the tremendous growth of the HP™, SC™&LP™ Cash Inflows!

The VB™ will be the exclusive solution to the Calamity that is caused. As a result of the conventional platforms methods of publishing accompanied by their presentation of constant updates. Relative to each Post onto the; Up Loading User Home Pages, Updates Pages and News Feed pages! These pages cannot accommodate every Post Going Viral & accompanied by their further Updates and Users Inputs relative to Each Post. Such an outcome will only result in Certain Catastrophe, whereby the outcome; to simplify one can imagine the creation of a Jungle of Undesired Information that will literally drive any Sane Person Insane! The preceding analogy is only the break-down of the calamity, relative just to a single Viral Post, relative to the Up-loading User HP™ Pages. It will be very easy for a person to use their imagination and visualize. What will be the outcome relative to a mixture of the other Post and more Viral Post for a Single User HP™ Pages! Conventionally for a Social Network to take the Initiative and accommodate the Data accompanied by Every Post Going Viral based presently on their business model. The resulting outcome will be that definitely a result in which their News-Feed, will become overwhelmed with Data. That will be in the nature of a Barrage of Seemingly, Endless and Useless Information. For the User such a product will result in their Certain Disinterest in the Social Network

The VB™ will progressively work to add a Dropshiping Company as an SC™. By possibly, executing the usage of the business

names; Abaydepot.bis™/Abaydepot.org™. That will possibly consisting of a mixture of the already existing dropshiping platforms; Doba and the fellow already existing Dollar Import Business, Khols Imports. The Return Policy for this prospected business will be crafted to progressively streamline the Return Dilemma. That is currently Hampering the dropshiping industry and simultaneously it will be the methodology. Which will works to “Weed” out the Worry-some Shoppers (those that buy with the intent to purposely return the product at a later time)! The Return Policy will place consideration on the contemporary fact that every Retailer (Vendor) within a dropshiping platform have their Individualized Return Policy and thus make it logistically difficulty for the dropshiping business platform, to centralize the associated Product Returns and service for the Genuine Shopper. The SC™ Specially Tailored Return policy will eradicate of this Dilemma!

The VB™ solution to this dilemma will be that each purchaser of a product from the dropshiping business will be having access to the ability to conduct direct returns to the supplier of their Product@ their own expenses. Thus, removing the dropshiping business from having to bear the Cost Associated with the Product Returns and simultaneously alerting the Shoppers. That they will be bearing the brunt of the burden, relative to Product Returns! Upon each purchase the Buyer will be provided with a pre-labeled Returned Sticker that bears the Return Address of each purchased product acceptable point of return for their goods and a copy of the product manufacture Return Policy/their Internet Links!

The VB™ will be a place for “Modern Life Every Shopping Needs.” So there will be the opportunity for the User to shop online. For residential purposes via a Drop Ship Link (SC™), (most feasible platforms to date; Doba and Khols Import) and for the Commercial/Whole Sale Shoppers an International Online Shopping Website (most feasible to date, Alibaba) and for Coupon Deals within the Suppliers/Manufactures chain on these Shopping Avenues an International Product Brokerage House (most feasible to date Market America). Each purchase of an item via Indulgences of the VB™ can be optionally be subjected to a crossed checked Regiment. For Present Lowest Price at Time, against all available e-commerce data, through its (VB™) Own Designed Cross-check Website! The VB™ will be deducing an, Associated Cross-check Fees from the Participating Platforms.

This SC™ will align a shadow Drop down Menu of appropriate contrast that will clearly display the risk and disadvantage of shopping at, another website other than that of the; VB™ owned Portals/by not using the VB™ as a Primary Linkage Website. The issues relative to the; Counterfeit, Condition, Quality of Items Security of Payments and Information Stored will be highlighted! It will also display the info that the Consumer must at All-time Have the Free Will to Shop at any place of their choice! That all sales that go through via the VB™ will generate a Minute Commission for the VB™. There will be a heavy emphasis on the benefits of shopping, securely via the VB™ facilitated sites, stressing heavily on the QL™ Security Mechanism that the VB™ posses.

The drop shipping business within the VB™ will be initially having the USA, as its Primary Target Market!

The VB™ will function in a mode, that will facilitates these actions; When a User act upon a WA™ their action will be automatically be feed into their News Feed/other pages of the HP™. That will be based upon the User set Post Publishing Preferences. All of the User+™ will automatically be informed. About each action, relating to their Imputed Content via the HP™ method of Choice. That will be of the intent to provide them with a reasonable level of Understanding, as to their Post influence on the public. The VB™ Publishing Spread will be intentionally designed to provide a Working Environment. Where by its operations will not interfere the normal functioning of the HP™.

The VB™ will allow the HP™ to set a threshold for how much updates will be allowed for a Post. That will subsequently be auto-feed into the User+™ conventional News Feed on the HP™. This will be relative to each Post that will be viewed via WA™ in combination with their Sharing Preferences. It will allow the user to access via their Home Page on the HP™. It will immediately provide the ability to make their Post/a Desired Post go Viral via a Payment Structure. Without having to rely solely on their accounts members of; Friends, Following and their Share Actions, as their mechanism of exercising “Flogging” of their Posts! These actions are very limited in their Capacity to Deliver!

The VB™ feature of FA™ will be engineered to produce a definite outcome. In that there will be a Guaranteed Recompense for all recognizable Indulgences for all of the HP™ Users interactions with the WB™!

The VB™ usage will result in the Expeditious Tracking and Broad Base Returns on all Posts. IT will provide the ample opportunity for the Users to Immensely Broaden their Friendship& Following. Outside of Conventional Platforms Friendship Networks and Advertisers will relish this ability to reach massive amount of people!

The VB™; WA™ will be the medium that will provide the Opportunity for Users to Further Interact with People that are not a part of their Friends/Friendships Network irrespective of their Conventional News Feed!

The VB™ will carry a super Viral Cabinet that will contain the details of all Posts that have surpassed 10 Million Hits, etc. That will be used to equate the Fees for Future Postings by repeating Up-loading Users and will not be just limited, to that specie of usage!

### Relative to the Characteristics of SC™/LP™

The VB™ will pursue as an SC™; the formation of a software company that provides Routes Information that connects all Delicatessens and Convenient Stores, in the USA on the basis of; state-by-State, TownNillage-by-Town/Village and County-by-County, categories and in other Nations via similar Geographic & Demographic Classifications. It will utilize as it Data Rostrum, the Methodology of Data Gathering that the Inventor of the VB™ has ceased upon! This software will be used by Products Distributors and it is a very Large Open and Untapped Market!

The VB™ will peruse the creation of a Brokerage Platform as an SC™. That will be for the procurement of Plans for both Pre-paid and Paid Phone Service. With both National & International Reaching Scope! It will be placing more heavy emphasis on the sector of the Pre-paid Service considering the fact that it is of a business approach. That is capitalizing on a largely Un-tapped Market in the United States etc! The Pre-paid Phone service, sector of the SC™ will be focusing. Its energies on making available to the public, the Opportunities of having the option to Purchase Pre-paid Cellular Telephone Services. That it will deduce, as result of very Extensive Detailed and Cross-Checked Carriers Data! The resulting Pre-paid Service Plan will be of the Cheapest Prices! The said will be the same for Paid Telephone Service Plans.

The VB™ will accepts companies to become LP™ after they have paid an Acceptance Commission and as it works its self to “becomes the Father of e-commerce by luring/encourages business to join its network.

The SC™&LP™ will be Allured; Simply by the Density of the HP™ Users Base to make the move and join the “Web Work”, that is Serving as the Highways to Economic Prosperity! To the contrary Entities that have chosen not to join the “Web Work” will become the Comparison Mark. For Entities, that is in Similar Business Industries to Use and Draw Comparisons, relative to Prosperity and Failures! The review of prosperities will be available to it Participants to Illuminate the Achievements in the Volume of Economic Blessings. They have Intentionally Chosen to Accept, by just Joining the “Web Work”!

The VB™ will Cause an Increase in the HP™ User Base by a Monmouth Volume.

The VB™, On box will be equipped with an Auto spell-check feature.

The VB™ is the Holy Grail of Business Models Patents and is of the Potency to re-verb aerate rate as the New of Age Global Economic Instrument & Model!

The VB™ will keep within its On Box & an Independent Section for Post that have being sent for FA™ in relation to each User that uploads a Post on to it. The OB™ will be able to at any convenient time to the Users and as a result will be able to conduct Image Search across the Internet.

I have found that the Physiological Rewards from a Positive Response from a Post are Very Heartening!

The VB™ will be unrestricted opportunity for its Users to broaden their Friendships, Followings and Financial Earnings! This will provide the Ideal Opportunity to the Financially Deprived Individuals. That's a sizeable percentage (%) of its Targeted Potential Customers, to possible become Users+™!

The VB™ mechanism of FA™ will actively address and eradicate of the Dilemma, which is within my personal experience. It relates directly to my assumption that other Social Network Users have also experienced the same! It Pivots around my Posting on Facebook (FB)! In this experience I haven't received any Like/Dislike/Comment relative to a Post that I have uploaded onto FB! My Intelligent Conclusion is that the updating of MY News Feed/Social Circle Updated™ (SCU™) was purposely stifled by FB, Algorithms. That they are Generally Designed to Over-control what All Users See and what they should Not See. By progressively placing Capitalisms as there Foremost Goal above the Desires of its Non-commercial Users and are surreptitiously using the Regular Persons (Non-commercial Users) as a Mere Number (within a Broader Pool of Usable Numbers) within an “Emotionless Capitalistic Pursuits”!!

The Viral Booster Recompense Regime™ (VBRR™) & Rewards Dynamics:

(a) Payments to the users will be the instrument that will work to provide the incentive for indulgences a Post and their rating Effects. It will further become the Sustainable Rostrum for Users to build New Likenesses/Followings, on the HP™.
(b) Payments can be made out to Users on a Pre-agreed Structure depending if the User decides to use their Monies as a Bank/Investment Account!
(c) Payments will be equated in a manner whereby a greater volume for more Expressed; Characters, Emoji, Symbols and Grammatical Markers within Float˜™ that will result in the Tallying-up of Monies (“PiPs”) towards the VB™ Recompense Regime (VBRR™)!

Money does Draws People like Honey does to Bees!!

The VB™ will provide for Advertizing Based Post (Commercial Posts) the opportunity for Users to be able to Present a Purchase Receipt Number (#), a Bar Code an Advertiser Specific Displayed Code (marketing Promotion). Within the Booster Section (BS™) of an Advertisement, that will result in the equating of a percentage of a “PiP” to their VB™, Based Recompense Regime!

These Recompense Structure will be Pre-negotiated between the Advertisers and the VB™!

The VB™ will be a business operating as an independently standing economic entity within the HP™. When User action on a WA™ is initiated it will be allowed; to continue for as long as necessary, as long as intended or to be kept on a hold on the Users Hold Box™ (HB™) within the VB™! It will be guaranteed that any action of Initiation relative to a WA™ will be Compensated for Disregard-less of the Actions and its Delayed Time!

The VB™ does recognize that Social Media Users Time and Indulgences, are very precious to them and Paying for that Time and Action is what the VB™ is going to be Doing! With emphasized consideration for the clutter of irrelevant information that conventional Social Media Users are constantly being bombarded with the Recompenses from the VB™ will facilitate the development of a “Mental Mind Change” by the Users whereby. They will be able to Comfortably Grapple on Every Opportunity to Interacts with WA™! It will Further Motivate Users to interact with WA™. That they might have initially considered as mundane/irrelevant during their Previous Mind-set! The Recompense will motivate Users to Multi-task and pay more emphasis on the information at hand and not to follow their usual manner. Of browsing through the List of Information with the intent of selecting Familiar/Desired Materials! This Newel Enhanced attention by Users will translates into Economic & Social Gains for all Paying Parties!

The VB™ will not going to award Recompense to Users+™, for their Indulgences towards Posts that they have authorized, to experience the usage of FA™! The VB™ execution of FA™ is nothing less than “Blitz Advertizing” and it is the Super Bowl of On-line advertizing! The continuous and sustainable accessible connection between the VB™, HP™, SC™, LP™, ChinStine™ AVRP™ & CWW™ will actively facilitate the profuse Business Traffic, to interflow within them!

The VB™ Recompense Regime will be a Major Motivating Factor for HP™ Users to pay attention and acts towards WA™! The broad based spread of the WA™ will be a guaranteed that the Concept of FA™ will bring Fruition to the HP™ for an Infinite Length of Time!

### The Equating Dynamics of the VBRR™

The Payments will be made out as a Total of acquired “PIPS” that are equivalents to a pre-determined percentage of a US Penny/Equivalent Currency! The usage of the “PIPS” within the VB™ Payment Structure is an intentional exercise because it capitalized on the Premise. That the Mental Psyche of the General Human being is an Environmentally Acquired& Programmed Characteristics; in that they Pleasingly Acknowledged, Large Numerical Values, of Rewards for an Accomplishment, as to the Factual Representations. Of its Real Monetary Value, as “the Alternate Mental Pleasure Medium”! This New Mental Psyche within the Conventional Human being is the Modeling Factor together with the Usage of the “PIPS”, within the VB™ Recompense Regime!

It is Amazing to know what “People will Pay to be Published.”

The VB™ will reserve the Rights to refrain from the payments of Recompenses to the HP™ Users, for all/any of their Post that have being exposed to FA™. This will be a possible means to secure the HP™/VB™ Recompense Regime from abuse, by Users+ at any given time. Although the Broadcasting Spread of the FA™ should be a Substantial Counter-mechanism to any of such a Sinister Act. Especially when the elements of the FA™ Broadcasting Spread is factored, in to the Operating Equation with the Allotted Interactive Broadcasting Time. That a WA™ will be exposed to, the Equation will amplified the fact that the volume of Time that the Users will have at Hand to Cheat relative. To the Time a WA™ will be exposed to FA™ will be very short and as such it will be very difficult. For any Orchestrated Payments Fraud to be perpetrated by the Users!

The Users activation of WA™, via a Platform that is not the VB™/HP™. Will result in the HP™/VB™, being immediately made acquainted. That of such an Action is taking place and in-turn is able to recognize the “Tractable Signature”. Of the Devise that is in Use to Sign-in to the HP™/VB™ Account/s! This ability will be the enablement that will allow the Benefits of the VB™ Recompense Regime to be directed to the Correct User!

What can be a More Alluring Feeling than the Receiving of Monies for Ones Act?

The VB™ will rigorously pursue a “Bolster Sale Regiment” in the nature of offering Physical Property for Periodical Grabbing's e.g. the availability of Prizes will be the periodic (quarterly) rewards for an Silent Competition. The propelling ideology behind the Bolster Sale Regiment is that “Money in combination with Large Concrete Rewards Drives People Desires.” Among the other Prizes within the “Bolster Sale Regiment” will be; Real Estates, Wins for Life Monies, Vehicles and for Non-US Nationals the Mere Legal Rights to Immigrate to the USA and Live!

This Multi-Layered Rewards Model will be the Never-ending Reason for the continued usage of the VB™ via the HP™, by People!

These Rewards will be dispersed relative to the Sectionalized Demographic, Geo Political & Geographic Data. That the VB™ will be using to zone Users into various Economic Based Targeted Groups. This as the conjoining Payments Structure with the VBRR™. Will serves to motivate people and provide them with the reasons to schedule/make available their Daily Time to accommodate Social Media Activities on the HP™, VB™, SC™, LC, AVRP™, CWW™&ChinStine™!

The relative tallying of UA™ and its visible placement, as it relates to each individual Post, on to the HP™ Pages. That will be Used to stimulate, a Silent Competition among the HP™ Users Community!! A competition that will be center around the Privilege, to Claim the Crown for having a Post with the Superlative of Users Hits! This Competition will work to Foster a Posting Barrage, on the HP™!

The VB™ will work to further Grow and Enhance Social Relations on a broad scale that will result in the making of Followings and “Newly Found Bonding Groups” of Users on the HP™!

The VB™ will allow for everyone to; Post, Share, Build Friendship, Following and Bonding Groups, on a Single Platform all without having to resort, to the usage of Multiple Mediums. That will Transition into a Positive Feed from the HP™ to its (Users) Advertisers!

The VB™ is in direct contrast to the Conventional Platform marketing strategy that are generally slow to bear results and very difficult to trace their direct and Effective Usage. Considering, the fact that Speed is very important for entities that are dynamic and needs to get their Messages to the public in a Very Expeditious Manner! The Relevant Marketing method used by Conventional Platforms is underpinned within the premise that the Data gathered by the Platform is factual. On the basis of the active assumptions of the Computer Program, that makes these decisions for them but to the Contrary it's Widely Known among the Community of Developers, that these Programs can be riddled with Flaws!

Statically, the Users of these Platforms, can testify to the Experience they are having. Within which, ninety nine percent of the time, Conventional Relevant Marketing Broadcast have failed to continuously deliver what they, wants to See/Immerse their Actions Into!

The VB™ is promoting the Philosophy that “In the True World Everyone is Relevant” until proven Otherwise and therefore in the World of Free Expression and Commerce its Mechanism of FA™ is the Most Efficient Tool for the Advertisers & Non-business Oriented Users, to Use! It will increase by many fouls the amount by numbers of Users that will be available at any time period. To respond to a Post by taking an inquiring action! As in contrast to the Conventional Platform Actions that is drastically reducing such actions due directly to their Marketing Model, especially the usage of Conventional Relevant Marketing!

The VB™ will cause the HP™ Users to be Baptized into Fervent and Loyal Users of the HP™. The creation of a Breed of People, which generates a heavy dependably in the operations of the

HP™, VB™, ChinStine™, AVRP™, SC™, LP™&CWW™, for both Social Interactions and Money. This will make viable economic sense!

What a great felling it will be when someone is getting Recompense, for something they have done. That can be at minimum, just an act of Interacting with a Post and Leveled a Recorded Reaction towards it!

The VB™ will result in the sale of FA™ (Cross the Board Advertisements) including its TBP™ and Conventional Relevant Marketing on the Very-same Web Template without any Entanglement what so ever!

Its WA™ will be a Portal to a New World and they will bring to the Users a New and Unique Experience. That will be unlike any other and shall be on every Feasible Medium of the HP™, VB™, SC™, LP™, ChinStine™, AVRP™ & CWW™ in Variable Concentrations.

The VB™&HP™ users will be guaranteed of the spread of their information and the value for their Monies!

My personal experience have led me to conclude that a majority of the times the Contemporary Platforms Programs (Algorithms) are using very little Relevant Triggers as leads to develop Targeted Results. Thus they are Unable to Deduce the Rightful Broadcasting Spread for each Post!

The VB™ will bring into service the Chins Reader™ (CR™) as an SC™ that will be in the nature of an Optional Auto Program that will read all the HP™ Users emails based on their Subscription Privileges and it will inform the User via Audio of their contents! It will be conjointly augmentable with; ChinStine™, AVRP™ &CWW™ and becomes the platform that can resend Verbally Dictated Emails. To the Desired Parties, upon the Audio Urging of the Users, these emails will be hosted on conventional web platforms/the HP™ Servers! That will be equipped with the Special Ability to produce Printed Copies of these Emails upon the Audio Request of the Users!

The CR™ will not be limited in Further Development Capabilities and will be made to be compatible with all of the conventional emails platforms! It will help to simplify life in a Chaotic and Hectic World!

The VB™ will enable the HP™ Internal Search Engine to readily Search through the VB™, Catalog of listed; SC™ and LP™, ChinStine™, AVRP™ & CWW™ in a Google like Suggestive Nature and locate the Entities. That the Users are seeking to interact with! Its Users do not have to resort to usage of additional Apps/Methods to enrich/enhance their chances of connecting with a Sizeable Audiences; it will all be readily available based on the usage of the VB™!

The VB™ will be Selling Advertising via an extremely Appealing Digital Front and to the contrary of the conventional methods, of making a Post go Viral. Those that are resting, their reliance on the strength of the Users networking and their members/friends subsequent actions, which is a mechanism with immense limitations!

The VB™ will be the Epitome of a Coherent & Symbiotic Global Business Networking and will be nothing short of a Global Economic Model!

The businesses don't like to wait for results especially when they have invested their monies in advertising. The Good News is that the VB™ will provide the means to change all of that in an instant!

The VB™ is predicating the Mantra that it business model will Hammer on the Concept. That “Concurrent Broad Base Content” on the HP™ will increase its Economic Performances by a “Stellar Margin” and will be Empowering its Users. To make decisions by allowing them; to a Look & Decide for themselves on what Content they will appreciate to (Indulge) View & Critic! Additionally it will contribute to the effect of the “Stellar Margin” by empowering its Users with the ability to Super Securely Shop Online & Transact a Multitude of Business! It will be the medium that will allow its Users to connect to the Internet via any Wi-Fi Ready Device. Without a Time Restraint and any Connection Fee, being applied.

Chin™ will be the will be the designated Voice Command Character (Avatar) of the HP™ as a result of its augmentation with the VB™! It will execute its functions similar to the Apple Voice Command, avatar Sid!

The Attention Grabbers EIDDHA™ WA™ &VL™ will individually/collectively express all of these Traits;

The WA™ main Expressive Characteristics is that it is an; Evocative, Shrink-down Version of a Post!

The WA™ invigorations by means of the Users action directed towards the EIDDHA™. It will trigger an Auto Double Sequence Action that will result in their subsequent; Timely Opening and workable reception to Maneuvering, into an Appropriate Size, on the Users Devise Screen! The WA™ usage of Shifting Shapes and Colors during Display Mode will act as a mechanism to enhance its Aesthetic Quality!

The EIDDHA™ will be capable of being a Morphing DNA representation that will be very alluring! It will be indicative of rapid development and regression in a Transcending Nature. Together in synchronizations with the WA™ that will be that of an Evolving &Evocative Instrument! The WA™ will be positioned in practically workable configuration. To attain the functional goal of having the most WA™ Conceivable, in functioning order for each EIDDHA™, at any given Time Period!

The Pages of the VB™, HP™, SC™&LP™ can display a variety of WA™ Configurations within, their Web-site Architectures!

The VB™ Quantum Lock™ (QL™) Qualities & Discussions; Relative to the Subject Matter of Security and the VB™ Pre-eminent Enablement! As a One Digital& Social Media Package, that will comprise Chiefly of a Conjoining Business Relationship. That inter-twines, functionality within the; HP™, SC™, LP™, AVRP™, CWW™&ChinStine™ compounded with it as a Blanket Internet Rating House ! That will be engineered to function as two (2) and more Web sites operating on a Single Front Basis (Entrance Domain Name). Whereby, a Designated First Domain Name (HP™, etc) will be a part of a Concatenation of Domain Names & Security Mechanisms. That will provides a direct and fast entrance to Separately Secured and Independent Web Sites (VB™, SC™, ChinStine™, AVRP™, CWW™&LP™). With different Domain Names (component of the QL™) such as the preferred e.g. (abaydepot.org™), In a Super Expeditious and Effective Manner!

The QL™ will be the Layered Security Mechanism within the operating functions of the VB™. That will exemplify the operations of transactions through a; Double Domain Name feature that will be an inhibitor to the Common Crime of Hacking! With emphasis on the fact that the VB™/HP™ will be holding within its ASTM very Sensitive Information of the Users and placing consideration for the prospect that the VB™. Will also have, within it repository Sensitive Information relative to the; HP™, SC™, LP™, ChinStine™, AVRP™ & CWW™.

The inter transfer of information between the; HP™, VB™, SC™, LP, ChinStine™, AVRP™ & CWW™ will be formulated to operate as a system that mimics the operations of a communication Channel. That Administrate Information Transfers between a Primary Domain Name and a Secondary Domain Name! Whereby the intended direction of the flow of Information will dictate the On-demand function of a Domain Name! This method of Information Transfers will create an Information Transfer Gap! That will be Filled& Protected by the Infusion of an Automated Shut-Down System Mechanism. That will use Quantum Cryptography, as it trigger to prevent an Illegal User (Computer Program/Hacker) from accessing the Website protected, by the then Delegated Secondary Domain Name. The System of Quantum cryptography will coordinate with the Log-in Security system (Pass Word) that will be layered before the primary Domain Name. The Pass Word will utilize a layered combination of RSA & the CAPTCHA Security Technology to Trigger the functioning of the Quantum Cryptography System. By, telling it to Deny Access to the Wed Site, that it will be protecting, on the other side, of the Delegated Second Domain Name. This System will be formulated with the primary gold of preventing Remote Accessing into any of the Websites that are within the VB™ Networks of websites! The implementation of a Bio-Metric Reader within the Security systems of the VB™ Networks of Websites. Will be used to detect and intercept a Human “MOLD” from continue accessing the Networks. It will operate on the premises whereby; the First Interacted Interface will request a Biometric verification when it detects Subtle, difference in the Interactive Patterns of a User.

The VB™ will be used to Remit Monies for Users and it will be rigorously perusing the avenue of acquiring the Remittance Platform, Money Gram to be an SC.

### General Commentary

There will be the implementation of a Third Dimension Mode of Broadcasting (FA™), within the functionality of the VB™. It will have among its Constituents of Mechanisms/Apparatus a Voice Activate Computer Program. That will be made operable via a Smart Speaker, Named the ChinStine™. It will operate, on the premise whereby the Users Voice Request. On to a ChinStine™ that will cause the VB™ broadcasting mechanism of FA™ to be placed into Audio Motion. The Audio Motion will cause ChinStine™ to present Audio Based WA™, by announcing the EIDDHA™ in synchronizations with the WA™. These announcements will be in the nature of a Background Sound, accompanied by a higher pitch of an Announcing Voice. Which will present the categories of the WA™ relative to the name of Humanly known Names and Things. The Users will be allowed to select and mentioned the name of their choice and in turn ChinStine™ will announced the Audio Messaged WA™. The Users will subsequently be able to verbally expressed a Recordable and Transmittable; Like+™, Dislike−™/Float˜™ towards individual WA™. A privilege that will be providing the User with the opportunity to obtain Recompense for their Interactions via the VBRR™! ChinStine™ will be equipped within it designs perimeters to directly host a TV Screen, a Computer Monitor or an Augmented Reality Interface! Which will be Used to simultaneously present a Visual Display of the WA™ that will be requested via Audio Request. This privilege to utilize the VB™ broadcasting mechanism of FA™ will be Serviced by an Hybrid Version of the VB™ Recompense Regime!

As the FA™ (Broad Marketing) sector of the VB™ is made manifest on to the HP™. The other remaining sectors of its Business Model sectors can be implemented progressively!

The VB™ will be the solution to the, Genetically Shackled Broadcasting Problem. That conventional Social Media Networking Platforms; like FB and Others are Transcending, to their Users! It is a Dire Problem that has its genesis rooted within the Fundamental Layout, of these Platforms Web Architectures! To counter these problems the Users are forced to develop Unique Creativities& Acumens. Those have a heavy reliance on their Friends Networking Strength (share actions). In order for them to be able to explicitly pierce and breakout of these websites Inherent Deficiencies, make their Posts go Viral and simultaneously be able to have all Generated Interactions of these Posts to be Hosted within their News Feeds/Updates! The Designs within the VB™ mechanism of FA™ are purposely Created to eradicate of this Dilemma!

The VB™ will effectively counter and solve the Dilemma, that FB (Face Book) Market Exchange Programs are presenting for it Users! This Dilemma is within the workings that, FB is allowing Business Entities; to Inundate Users with their Advertisements and in so doing is intentionally Denying them of the “Variety Possibly!” These Orchestrated Acts should be viewed by the Users; as “Open but yet Subtle Physiological Marketing Maneuver,” by FB. Intending to create a means to Smoothly Limit People Pursuits to Seek and Find Competing Prices other than what it is promoting. This maneuver by FB works to serve its Self-Centered Capitalistic Goals (more advertizing monies) and is tantamount to a Word “Highway Robbery”.

The VB™ will provide the opportunity for every HP™ User especially the Non business Oriented Ones (the ordinary people) to have their Content to be broadcasted to the largest audience as possible! Thus Removing them from the “End of the Stick” as the Disadvantaged Product of Commercial Users and allowing them to mold them self as Significant Player in the Social World!

The VB™ is going to be the Largest And most successful Business Web in the World!

The VB™ will introduce the Chins Reverse Search Dictionary™ (CRSD™) as an SC™! It will be utilized by HP™ User that understands/have within their Frame of Mind. The meaning of a Word they are looking for but do not know what the Word is! They will be able to introduce their thoughts of meaning, for the Illusive Word into the Search Engine of the CRSD™ and they in turn will be provided. With the Free Privilege of being able to see/hear via Audio the meanings of a List of Words that may fit their Desired Usage!

The CRSD™ will be economically sustainable via its Advertizing Revenue!

The VB™ will causes the HP™ to caters both to the Paying & Non-Paying Users simultaneously and in so doing the HP™ will not produce Intentional Interference between these Classes whatsoever !

The VB™ will send alerts to the HP™ Users when their Post is trending. These Alerts will be in the nature; of Auto-emails, Text and Notes directed towards their HP™ & VB™ pages as the VB™ Operating System will deemed appropriate. The preceding privilege will allow the SC™ and LP™ to be Integral Components within the Broad Social Conservation and simultaneously allows them the Blessings to be at the Receiving Helm of the HP™ Users Base thus facilitating a Coherent& Symbiotic Economic Relationship within all of the Participating Parties!

The VB™ will cause an alert to be instantly sent out to the HP™ users when they are being un-friend by a Fellow User! These notifications' will help Users in order to better Track and Handle their Social Relationship!

The VB™ will become the largest and most Establish Practical Exercise of Business Interdependency! If a business fails to accommodate the operation of the privilege FA™, they will risk the possibility of Failing to Reach that Special Community of People! It is going to be in direct Contrast, to their Competitors and for the Non-business Post Users of the VB™/HP™. They will be left with the Toxic Options; of having to Resort to using the So-called Experts Tips/Tricks to make their Post go Viral! In so doing they will have to Individualize their Actions for Each and Every Post. That they wants to go Viral (a Gargantuan Task) and simultaneously placed them self in the precarious situation of Eminent Failure! The SC™&LP™ will be allured by the Simply by the Density of the HP™ Users Base to make the move and join the “Web Work” that is the Highways to Economic Prosperity!

The VB™ Users will be progressively provided with information relative to the progression of their WA™.

The VB™ will be in stark and Advantageous contrasts to the Users+™ relating; to the Dynamics within the Economic Fruition of Conventional Social Networks! In that these networks cannot publish the Full &Continuous Updates for Each and Every Post onto their wed pages. It will only result in their Visible Publications/News Feeds being over whelm and only becoming a Clutter of Irrelevant Information to the Users!

The counter response by Conventional Social Networks to this Publication Dilemma (Inherent Limitations) is that they are resorting to the usage of Specially Tailored Algorithm. That works to stifle Individual activities from being published within their publicly visible Updates/News Feeds, thus creating an Immense Disadvantage to especially the Non-Business Oriented Users!

The VB™ will readily facilitate a Smooth and Unnoticeable Interflow of Traffics between the HP™&VB™.

The VB™ will be the Portal to the “A New of Age World in E-commerce!”

The VB™ will engineer the Appointment Doctor™ (AD™) as an SC™. The AP™ will be a Universal Website/App that can be utilized by the Users to, Make Online Appointments to both Human & Animal (Pet) Utilizing Doctors! All of the Participating Insurance Carriers, with their Respective Networks of Doctors, will be facilitated! The Classifications of the Information within the AD™ will be systematically accessed by the Users based on a Sectionized Data relative to; Country, State, County, City/Zip Code& Telephone Area Code. The Facilitations of the AD™ of Users; in the Making and Confirmations of Appointments, to all of its Utilizing Doctors will Immensely Centralize & Simplifying the Doctors Appointments Processes!

I claim:

1. A method that is comprising of a digital and mechanical mixture of implements and computer programs that is utilizing the continuous usage of EIDDHA™ in conjunction with WA™, as it is inter-twined with an HP™, to become a Cohesively Functional Apparatus that is bearing characteristics that are diverse but yet stratify-able to be considered, as a unified system that is expressing a mixture of new and useful functionality that are interrelating to the workings, within a multitude of collective apparatuses that are having among their Webbed Cluster the usage of; web-tools, websites, web-applications, mechanically operated implements, practicing businesses, virtual platforms, the Users interactive interfaces, BOTS, avatars in conjunction with uniquely designed and named computer programs that are used to purport the selling of Advertising/Free-speech via e-commerce, as a product of an initiative that is uniquely engineered to effectively integrated, into the functioning architecture of any chosen website/s conjunctionally or dis-junctionally simultaneously, as it sustains the VBRR™, to derive a desired outcome, among which is the Viral Broadcasting of a Post.

2. The method of claim 1, further comprising of the method for the User to connect and interact with the VB™ and HP™ via these mediums; SC™, LP™, AVRP™, CCW™, ChinStine™ and VL™ that are serving the functions as the HP™ and VB™ User Interactive Interfaces.

3. The method of claim 1, further comprising of the method that is causing a Post to be contracted and expressed in the nature of a WA™ that is exposed to FA™ as it is being distributed and published on the HP™ and all of the other participating HP™ and VB™ User Interactive Interfaces.

4. The method of claim 1, further comprising of the method that is causing the unique classification and subsequent publishing of the User interactions on a HP™/the HP™ and VB™ User interactive interfaces hosted Post, that is producing resulting outcomes that are in the nature of a pictorial representation of their actions, that is in the expressed manner of an artistic layout, that is a depiction of two or more persons that are conjoining their hands together, an expression that will be published on the HP™ and the desired members of the HP™ and VB™ User interactive interfaces.

5. The method of claim 1, further comprising of the method to represent the Alluring and Interactive Web-tool (VL™) that is presented on the web pages of the HP™ and the participating HP™ and VB™ User Interactive Interfaces.

6. The method of claim 1, further comprising of the method that is sustaining the web-tool EIDDHA™ as it functions, as a Containing Basket that is holding within its confines WA™ and as it is simultaneously displaying an array of inherent characteristics among which is it's; morph-ability within in its display rhythmus that entails; the displaying of a variety of shapes and colors as, it is functioning to allure to the User during its displaying on the WebPages of the HP™ and the participating members of the HP™ and VB™ User interactive interfaces.

7. The method of claim 1, further comprising of the method that is presenting Advertising and Free Speech, directly relating to the promotion and marketing of the HP™/VB™, as Written Matter on the front/back of the Printed Sale Receipts of all agreeable mail/freight carriers in the United States of America, via arranged business agreements, within the parties that is serving the satisfaction of the VB™ desires.

8. A method that comprising and allowing the VB™ to integrate with HP™ and the participating HP™ and VB™ User interactive interfaces to produce a symbiotic system, that inter-functions with the operating mechanisms within the QL™ and simultaneously allowing the QL™ to function, as an effective Security Mechanisms.

9. Claim the method of claim 1, that comprising and is allowing the Users of the HP™ and User interactive interfaces to be exposed to the enjoyment of the privilege of TBP™.

10. Claim the method of claim 1, that comprising and is allowing the Users of the HP™ and the participating members of the HP™ and VB™ User interactive interfaces, to be exposed to benefits of a probationary Marketing Period, that is allowing them to be enjoying the privileges of FA™, on a Cost-Free Basis.

11. Claim the method of claim 1, that comprising and is allowing the VB™ to assimilate as an SC™ a software company that is utilizing the (gathered data that the inventor of the VB™ has ceased upon) publicly available U.S. State by State, Health Department records of all facilities that required a State Health Department Certification, in order to practice their business, the Deduced Information is used by the SC™, as a Common Denominating Source to filter out the names and locations of all convenience stores and delicatessens, within these States/geographic regions and subsequently, used the gather data to produce Geographically Systematic Routes Maps, that are connecting all of the convenience stores and delicatessens, these Geographically Systematic Routes Maps is used by Distributors of Merchandises; to readily Simplify and Streamline their Sales & Distribution Initiatives, as they sustains a User relationship with the HP™ and VB™.

12. Claim the method of claim 1, that comprising of the ability for the VB™ to provide for the User to fully enjoy the enriching experience contained within the abilities and qualities of the CRSD™.

13. Claim the method of claim 1, that comprising of the implementation and utilizing of a unique method mixture of mechanical and digital systems, to produce intentionally created sounds that are serving the purpose of the CAS™.
